(19) United States
(12) Patent Application Publication
(10) Pub. No.: US 2025/0115028 A1
(43) Pub. Date: Apr. 10, 2025

(54) INTERLAYERS AND LAMINATED GLAZINGS WITH LIGHT-REFLECTING BODIES

(71) Applicant: SOLUTIA INC., ST. LOUIS, MO (US)

(72) Inventors: JULIA CLAIRE SCHIMMELPENNINGH, NORTH BROOKFIELD, MA (US); PU ZHANG, SUFFIELD, CT (US); MATTHIAS HALLER, FRANKFURT (DE)

(73) Assignee: SOLUTIA INC., ST. LOUIS, MO (US)

(21) Appl. No.: 18/832,093

(22) PCT Filed: Jan. 31, 2023
(86) PCT No.: PCT/US2023/061639

§ 371 Date: Jul. 22, 2024

Related U.S. Application Data
(60) Provisional application No. 63/366,020, filed on Jun. 8, 2022.
(60) Provisional application No. 63/267,682, filed on Feb. 8, 2022.

(51) Int. Cl. B32B 17/10

(52) U.S. Cl. CPC B32B 17/10614; B32B 17/10036; B32B 17/10761; B32B 17/1077; B32B 17/10788; B32B 17/10935; B32B 2274/00; B32B 2307/416

(57) ABSTRACT

An interlayer for a laminated composite is disclosed. The interlayer of the present invention includes a polymer resin composition and an interlayer thickness and a plurality of deformable, visible, light-reflecting body precursors that deform or are capable of deformation to form cupped, visible, light-reflecting bodies when said interlayer is laminated between first and second transparent substrates to form a laminated composite glazing. An interlayer component sheet including a substrate and deformable, visible, light-reflecting body precursors; a laminated composite glazing including a plurality of cupped, visible, light-reflecting bodies; and methods for forming a laminated composite glazing are also described.

### FIELD OF THE INVENTION

The present invention generally relates to the field of laminated glazing interlayers and laminated composite glazings including, formed from or prepared using such interlayers.

### BACKGROUND OF THE INVENTION

As has been known in the art for many years, laminated glass or laminated glazing constructions that include a monolithic sheet or multilayer laminate of polymeric material such as polyvinyl butyral (often referred to in the art as an interlayer) sandwiched between rigid substrates formed of glass or transparent polymer material have well-established commercial utility in safety glass and security glass applications in the automotive and architectural markets. In these applications, characteristics such as penetration resistance, optical quality and durability are of paramount importance to commercial success.

In many of these applications, products that further include visually decorative or aesthetic features (while retaining other overall performance characteristics) may be desirable. For example, U.S. Pat. Nos. 6,824,868 and 7,727,634, assigned to a predecessor of the assignee of the present invention, generally describe decorative glass laminates and interlayers therefor wherein the interlayers include an ultraviolet printed image. More generally, decorative interlayer and laminated glass constructions are described in U.S. Published Patent Application number US2007/0172637A1.

Applications wherein a laminated glass or related interlayer construction includes contrasting or variable optical features such as transparency or visual detectability are also known. For example, U.S. Published Patent Application 2020/0262185A1 describes a so-called one-way laminated glass for installation in facades or for interior design that includes an interlayer composite arranged between and bonded to first and second glass panes and wherein a large number of paillettes with a light absorbing surface are arranged between first and second interlayers to achieve a visual effect. Further, U.S. Pat. No. 4,997,687 describes a patterned product having a three-dimensional appearance that includes a transparent substrate with a discontinuous pattern coating in combination with a second pattern coating on a separate surface wherein the second pattern coating is visible through the discontinuous pattern coating. Also, U.S. Published Patent Application No. 2007/0044731A1 describes a “bird friendly” glass product that includes a pattern which is visible to the normal avian eye but which may or may not be visible to the normal human eye.

Despite these advances in the art, there remains a continuing unmet need for interlayers and related laminated glass constructions that meet customer desires and expectations for new and improved decorative effect, visual impression, attractiveness, aesthetics and visual noise creation while maintaining the quality, safety and performance attributes required in laminated glass applications.

### SUMMARY OF THE INVENTION

In a first aspect, the present invention is directed to an interlayer for a laminated composite. The interlayer of the present invention includes a polymer resin composition and an interlayer thickness and comprises a plurality of deformable, visible, light-reflecting body precursors. In one or more embodiments, the deformable, visible, light-reflecting body precursors deform or are capable of deformation to a deformation distance of at least 0.05 mm to form visible, light-reflecting bodies with a cupped shape when said interlayer is laminated between first and second transparent substrates to form a laminated composite glazing.

In a second aspect, the present invention is directed to a laminated composite glazing. The laminated composite glazing of the present invention includes first and second transparent substrates with an interlayer therebetween, said interlayer comprising a polymer resin composition and an interlayer thickness; wherein the interlayer comprises a plurality of visible, light-reflecting bodies. In one or more embodiments, the visible, light-reflecting bodies are concave and are formed from deformable visible, light-reflecting body precursors during formation of the laminated composite glazing.

In a third aspect, the present invention is directed to a method for forming a laminated composite glazing comprising first and second transparent substrates with an interlayer therebetween. In this aspect, the method of the present invention comprises the steps of (a) providing first and second interlayer component sheets, each interlayer component sheet comprising a substrate and a plurality of deformable visible, light-reflecting body precursors; (b) assembling said first and second interlayer component sheets to form a multilayer interlayer precursor; (c) assembling a laminated composite glazing precursor comprising first and second transparent substrates with said multilayer interlayer precursor therebetween; and (d) subjecting said laminated composite glazing precursor to laminating conditions to a) deform said deformable visible, light-reflecting body precursors to form cupped visible, light-reflecting bodies therefrom and (b) form a laminated composite glazing. In embodiments, the method optionally further comprises inserting an optional spacer sheet, preferably without visible, light-reflecting body precursors, between the first and second interlayer component sheets.

In a fourth aspect, the present invention is directed to a method for forming a laminated composite glazing comprising first and second transparent substrates with an interlayer therebetween. In this aspect, the method of the present invention comprises the steps of (a) providing an interlayer with a thickness and comprising (i) a substrate comprising a polymer resin composition and (ii) a plurality of deformable, visible, light-reflecting body precursors; (b) assembling a laminated composite glazing precursor comprising first and second transparent substrates with said interlayer therebetween; and (c) subjecting said laminated composite glazing precursor to laminating conditions to (i) deform said deformable, visible, light-reflecting body precursors to form cupped visible, light-reflecting bodies therefrom and (ii) form a laminated composite glazing.

In a fifth aspect, the present invention is directed to an interlayer component sheet for an interlayer or for a laminated composite glazing that includes an interlayer. The interlayer component sheet of the present invention includes a substrate and a plurality of deformable, visible, light-reflecting body precursors. In one or more embodiments, the deformable, visible, light-reflecting body precursors deform or are capable of deformation during formation of a laminated composite glazing of the present invention to form cupped, visible, light-reflecting bodies.

Further aspects of the invention are as disclosed and claimed herein.

### BRIEF DESCRIPTION OF THE DRAWINGS

FIG. 1A is a front perspective view in cross-section of an embodiment of an interlayer of the present invention;

FIG. 1B is a front perspective view in cross-section of an embodiment of an interlayer of the present invention shown as a component or element of a laminated composite glazing of the present invention;

FIG. 2 is a front perspective view in cross-section of an embodiment of a laminated composite glazing of the present invention;

FIG. 3 is a top plan view of an embodiment of the laminated composite glazing of the present invention with substrates and interlayers transparent to show an arrangement of cupped, visible, light-reflecting bodies;

FIG. 4 is a top plan view of an embodiment of the laminated composite glazing of the present invention with substrates and interlayers transparent to show an arrangement of cupped, visible, light-reflecting bodies;

FIG. 5 is an exploded front perspective view in cross-section of an interlayer and interlayer precursor prior to formation of a laminated composite glazing and as applicable to an embodiment of a method of the present invention;

FIG. 6 is an exploded front perspective view in cross-section of the components of a laminated composite glazing as applicable to an embodiment of a method of the present invention;

FIG. 7 is an exploded front perspective view in cross-section of a laminated composite glazing precursor as applicable to an embodiment of a method of the present invention;

FIG. 8 is a side elevational perspective view of an embodiment of a deformable, visible, light-reflecting body precursor of the present invention;

FIG. 9 is a side plan view of an embodiment of a cupped, visible, light-reflecting body of the present invention formed from the deformable, visible, light-reflecting body precursor of FIG. 8; and

FIG. 10 is a front perspective view in cross-section of an embodiment of an interlayer component sheet of the present invention.

### DETAILED DESCRIPTION

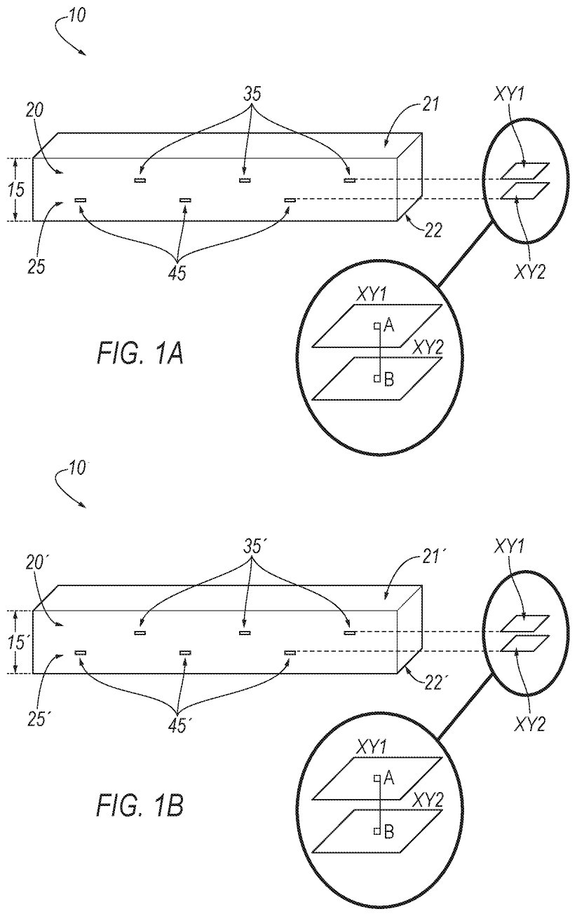

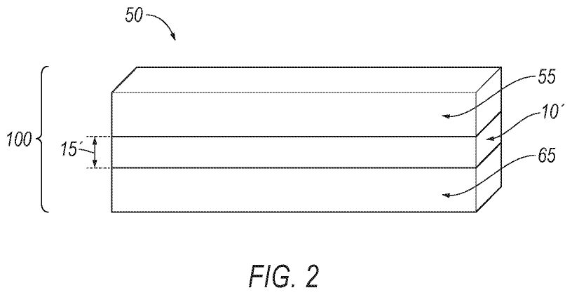

In a first aspect, the present invention is directed to an interlayer for a laminated composite. An embodiment of the interlayer 10 of the present invention, depicted particularly but non-exclusively in FIGS. 1A and 2, includes an interlayer thickness 15 and comprises a polymer resin composition and a plurality of deformable, visible, light-reflecting body precursors 25. In one or more embodiments, the deformable, visible, light-reflecting body precursors are located within the interlayer thickness 15.

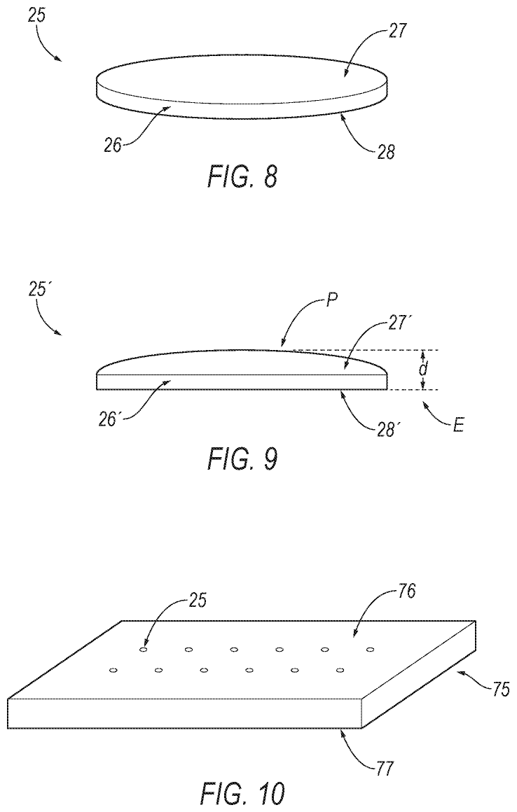

In general, the deformable, visible, light-reflecting body precursors may have any structure or composition that, when subjected to laminating conditions in conjunction with the laminated composite glazing of the present invention, deform to form cupped visible, light-reflecting bodies as described herein. As depicted for example in FIG. 8, a deformable, visible, light-reflecting body precursor 25 may include edge 26, a first surface 27 and an opposite second surface 28. At least one of the first surface 27 and the opposite second surface 28 may be generally planar. At least one of the first surface 27 and the opposite second surface 28 may be capable of reflecting, and in some embodiments absorbing, electromagnetic energy. The deformable, visible, light-reflecting body precursors may be substantially flat.

In one or more embodiments, at least one of the first surface 27 and the opposite second surface 28 may reflect electromagnetic energy in at least a portion of the wavelength range from 250 nm to 2500 nm or may reflect electromagnetic energy in at least portion of the wavelength range that is visible to or detectable by most common bird species. In one or more embodiments, at least one of the first surface 27 and the opposite second surface 28 reflect electromagnetic energy in at least a portion of the wavelength range from 250 nm to 700 nm.

In one or more embodiments, at least one of the first surface 27 and the opposite second surface 28 may also absorb electromagnetic energy, particularly electromagnetic energy in at least a portion of the wavelength range that is visible to or detectable by humans and/or may also absorb electromagnetic energy in at least portion of the wavelength range that is visible to or detectable by common bird species. In one or more embodiments, at least one of the first surface 27 and the opposite second surface 28 may absorb electromagnetic energy in at least portion of the wavelength range of 250 nm to 2500 nm and/or may absorb electromagnetic energy in at least a portion of the wavelength range of 250 nm to 400 nm (bird species). In one or more embodiments, the deformable, visible, light-reflecting body precursors may include a visible, light-reflecting first surface and an opposite, visible, light absorbing second surface.

In some embodiments, at least one of the first surface 27 and the opposite second surface 28 may include a surface with a color generally referred to as silver, but any suitable color(s) may be used as desired. For example, first surface 27 of the deformable, visible, light-reflecting body precursors may be a silver or similar color, while opposite second surface 28 may be a darker color such as black. In some embodiments, at least one of the first surface 27 and the second surface 28 may have a matte finish or a glossy or “shiny” finish.

In one or more embodiments, deformable, visible, light-reflecting body precursors deform a deformation distance “d” (as for example depicted FIG. 9) of at least 0.05 mm or at least 0.06 mm or at least 0.07 mm or at least 0.08 mm or at least 0.09 mm or at least 0.10 mm or at least 0.11 mm or at least 0.12 mm or at least 0.13 mm at least 0.14 mm or at least 0.15 mm or at least 0.16 mm or at least 0.17 mm or at least 0.18 mm or at least 0.19 mm or at least 0.20 mm or at least 0.25 mm or from 0.05 mm to 0.30 mm or from 0.05 mm to 0.25 mm or from 0.05 mm to 0.20 mm or from 0.08 mm to 0.20 mm to form cupped, visible, light-reflecting bodies. Accordingly, a visible light-reflecting body may be cupped and include a deformation distance of at least 0.05 mm or at least 0.06 mm or at least 0.07 mm or at least 0.08 mm or at least 0.09 mm or at least 0.10 mm or at least 0.11 mm or at least 0.12 mm or at least 0.13 mm at least 0.14 mm or at least 0.15 mm or at least 0.16 mm or at least 0.17 mm or at least 0.18 mm or at least 0.19 mm or at least 0.20 mm or at least 0.25 mm or from 0.05 mm to 0.30 mm or from 0.05 mm to 0.25 mm or from 0.05 mm to 0.20 mm or from 0.08 mm to 0.20 mm. Other deformation distances may also be used depending on the desired properties.

In general, deformation distance is indicative of the depth difference or degree of “cupping” between an edge of the light-reflecting body and point of peak or maximum deformation, preferably at the center point, of the body. “Cupping” is generally meant to include any deformation wherein at least one point of the precursor body is extended or stretched from a first or original position to a second or deformed position that is further from the precursor edges than the first position. With reference to FIG. 9, deformation distance may be calculated for example as the length of a line “d” extending from the peak deformation point of a light-reflecting body P and perpendicularly intersecting with a line E connecting two opposing edges of the light-reflecting body. Deformation distance “d” may also be measured using known analytical, optical, and similar techniques, methods and devices such as described in the Example set forth below.

In a non-limiting example depicted in FIGS. 8 and 9, the deformable, visible, light-reflecting body precursor 25 may include edge 26, a first surface 27 and an opposite second surface 28 and may be generally round or circular in shape and substantially flat. Upon deformation according to the method of the present invention, the visible, light-reflecting body precursor 25 forms a visible, light-reflecting body 25′ that may include edge 26′, a first surface 27′ and an opposite second surface 28′ and may be generally concave in shape, with first surface 27′ being generally convex opposite second surface 28′ which is generally concave. As used herein, “cupped” may be used to describe the visible, light-reflecting body and is generally intended to include visible, light-reflecting bodies including a first surface which is generally convex and an opposite second surface which is generally concave. The distance that a deformable, visible, light-reflecting body precursor 25 deforms during lamination to form a laminated composite glazing to form visible, light-reflecting body 25′ is shown as the distance “d” in FIG. 9. While the example depicted in FIGS. 8 and 9 describe a generally round or circular and substantially flat deformable, visible, light-reflecting body precursor 25 that deforms to form a generally cupped visible, light-reflecting body 25′, other shapes for the deformable, visible, light-reflecting body precursors that may deform to form a cupped visible, light-reflecting body 25′, such as square, rectangular, triangular, elliptical and oval, are contemplated. Accordingly, the descriptions herein, including those describing for example deformation, deformation distance and concave and convex surfaces are not and are not intended to be limited to embodiments where the precursors are generally round or circular.

As described below herein, the cupped, visible, light-reflecting bodies of the present invention are derived from the deformable, visible, light-reflecting body precursors of the present invention, with a general shape formed by deformation of the visible, light-reflecting body precursors during formation of a laminated composite glazing as described herein. Nonetheless, one of ordinary skill will appreciate that deformable, visible, light-reflecting body precursors and cupped, visible, light-reflecting bodies are essentially analogous elements, with the phrase “deformable, visible, light-reflecting body precursor” being used to refer to and generally describe the element prior to deformation during formation of a laminated composite glazing and the phrase “cupped, visible, light-reflecting body” being used to refer to and describe the element after being deformed in conjunction with formation of a laminated composite glazing. In general, Applicant has accordingly numbered these and other analogous elements with a “prime” notation when depicted in Figures in conjunction with a laminated composite glazing, for example FIGS. 1B, 2, 3 and 4, and without such a prime notation when depicted in Figures in conjunction with an interlayer or component interlayer sheet prior to lamination as a component of a glazing, for example FIG. 1A. By way of example, Applicant has labeled the deformable, visible, light-reflecting body precursors as element 25 in Figures wherein an interlayer or interlayer component sheet is depicted and the cupped, visible, light-reflecting bodies as element 25′ in Figures where a laminated composite glazing is depicted. Similarly, Applicant has labeled an interlayer as element 10 when an interlayer prior to lamination as a component of a laminated composite glazing is depicted and as element 10′ when depicted as a component of a formed laminated composite glazing.

Accordingly, an interlayer 10 as shown for example in FIG. 1A, prior to formation of the laminated composite glazing 100, includes an interlayer thickness 15 and comprises a polymer resin composition and a plurality of visible, light-reflecting body precursors 25. Once the interlayer 10 is laminated between first and second transparent substrates 55 and 65 to form a laminated composite glazing 100 that includes the interlayer as a component, as shown for example in FIGS. 1B, 2, 3 and 4, the interlayer is labeled as 10′ and includes a plurality of cupped, visible, light-reflecting bodies 25′.

As shown in FIG. 1A, the interlayer of the present invention, prior to formation of a laminated glazing including it as a component, includes a first set 35 of visible, light-reflecting body precursors 25 arranged in a first substantially coplanar arrangement in a first plane XY1 within said interlayer thickness 15 and a second set 45 of visible, light-reflecting body precursors 25 arranged in a second substantially coplanar arrangement in a second plane XY2 within said interlayer thickness 15 that is substantially parallel to and different from said first plane. As shown in FIGS. 1B, 3 and 4, the interlayer 10′ of the present invention as a component of a laminated composite glazing 100, includes a first set 35′ of visible, light-reflecting bodies 25′ arranged in a first substantially coplanar arrangement in a first plane depicted as XY1 within said interlayer thickness 15′ and a second set 45′ of visible, light-reflecting bodies 25′ arranged in a second substantially coplanar arrangement in a second plane depicted as XY2 within said interlayer thickness 15 that is substantially parallel to and different from said first plane.

As used herein, the term “interlayer” refers to a single or multiple layer polymer-based sheet that may be suitable for use with at least one rigid substrate to form a composite substrate. The interlayer of the present invention may be “monolithic”, meaning that the interlayer includes or may be formed of a single polymer layer, or may be a “multiple layer” or “multilayer” interlayer, which refers to interlayers including two or more layers which may typically be stacked upon one another, that are coextruded, laminated, or otherwise coupled to each other. One of ordinary skill will appreciate that interlayers formed from multiple component sheets, while definitionally multilayer in form, could take the appearance or form of a “monolithic” interlayer when for example the component sheets are compressed during a glazing lamination process. Such a result may occur for example when the component sheets are the same or materially similar in chemical composition.

As used herein, the terms “polymer resin sheet” and “resin sheet” refer to one or more polymer resins, optionally combined with one or more plasticizers and other ingredients, combined to form a polymer resin composition that is formed into a sheet. Polymer sheets may further include one or more additional additives and may comprise one or more resin layers. In some embodiments, the polymer sheet may be an intermediate polymer resin sheet or interlayer precursor used to form one or more of the interlayers described herein. Multiple polymer sheets may be combined together to form a multiple layer interlayer. Further, additional functional layers or sheets, such as a polyethylene terephthalate (PET) film, a coated PET film, or other layer, may also be included when multiple polymer sheets are combined to form an interlayer herein.

The interlayer or the polymer sheet(s) of the interlayer of the present invention includes, is formed from or is prepared using a polymer resin composition(s). The polymer resin composition may include various polymer resins known in the art for interlayer manufacture. The resin compositions may typically include one or more polymeric resins, optionally combined with one or more plasticizers, which have been formed into a sheet by any suitable method. Useful polymeric resins generally include without limitation polyvinyl acetals, thermoplastic polyurethanes, ethylene vinyl acetate, ionomeric resins and the like. In various embodiments, the interlayer or sheet or layer includes a polymer or polymer resin or resin composition that comprises a poly(vinyl acetal) resin and in particular a polyvinyl butyral (PVB) resin. PVB resin is produced by known acetalization processes by reacting polyvinyl alcohol (“PVOH”) with butyraldehyde in the presence of an acid catalyst, separation, stabilization, and drying of the resin. Such acetalization processes are disclosed, for example, in U.S. Pat. Nos. 2,282,057 and 2,282,026 and Vinyl Acetal Polymers, in Wade, B. (2016), “Vinyl Acetal Polymers”, Encyclopedia of Polymer Science and Technology, pp. 1-22 (John Wiley & Sons, Inc.), the entire disclosures of which are incorporated herein by reference to the extent not inconsistent with the present disclosure. The PVB resin is commercially available in various forms, for example, as Butvar® Resin from Solutia Inc. (which is a wholly owned subsidiary of Eastman Chemical Company). Examples of suitable types of poly(vinyl acetal) resins are described in detail in U.S. Publication No. 2016/0159041A1, assigned to the assignee of the present invention, the entirety of which is incorporated herein by reference to the extent not inconsistent with the present disclosure.

In one or more embodiments, the polymer resin composition, sheet or layer may include two or more polymer resins such as a polymer resin blend. In one or more embodiments, the two or more polymer resins may comprise two different types of polymer resins or two different polymer resins of the same polymer resin class. In one or more embodiments, an interlayer, layer or sheet may include two or more poly(vinyl acetal) resins having different levels of residual hydroxyl content (such as where the residual hydroxyl contents and/or the residual acetate contents are different).

In one or more embodiments, the polymer resin composition, interlayers, sheets or layers of the present invention include or are formed or prepared using a polymer resin that includes polymer resin (as discussed above) and optionally at least one plasticizer. In some embodiments, examples of the plasticizer include esters of a polybasic acid or a polyhydric alcohol, among others. Suitable plasticizers include, for example, triethylene glycol di-(2-ethylhexanoate) (“3GEH”), triethylene glycol di-(2-ethylbutyrate), triethylene glycol diheptanoate, tetraethylene glycol diheptanoate, dihexyl adipate, dioctyl adipate, hexyl cyclohexyladipate, diisononyl adipate, heptylnonyl adipate, dibutyl sebacate, di(butoxyethyl) adipate, bis(2-(2-butoxyethoxy)ethyl) adipate, and mixtures thereof. In some embodiments, the plasticizer is 3GEH.

In some embodiments, the plasticizer may be a high refractive index plasticizer. Examples of high refractive index plasticizers include, but are not limited to, esters of a polybasic acid or a polyhydric alcohol, polyadipates, epoxides, phthalates, terephthalates, benzoates, toluates, mellitates and other specialty plasticizers, among others. Examples of suitable plasticizers include, but are not limited to, dipropylene glycol dibenzoate, tripropylene glycol dibenzoate, polypropylene glycol dibenzoate, isodecyl benzoate, 2-ethylhexyl benzoate, diethylene glycol benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, di-2-ethylhexyl terephthalate, bis-phenol A bis(2-ethylhexaonate), and mixtures thereof. Examples of particularly suitable high refractive index plasticizers are dipropylene glycol dibenzoates, tripropylene glycol dibenzoates, and 2,2,4-trimethyl-1,3-pentanediol dibenzoate.

The polymer resin composition may comprise 0 to about 120, 0 to about 80, about 0 to 45, about 10 to about 75, about 15 to about 60, about 25 to about 50, about 15 to about 50, about 10 to about 40, about 15 to about 40, about 25 to about 38, about 29 to about 32, and about 30 phr (parts per hundred parts resin) plasticizer or a mix of plasticizers. The polymer resin composition may comprise 0, at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95 and at least 100 phr (parts per hundred parts resin) plasticizer or a mix of plasticizers. The polymer resin composition may comprise less than 120, less than 115, less than 110, less than 105, less than 100, less than 95, less than 90, less than 85, less than 80, less than 75, less than 70, less than 65, less than 60, less than 55, less than 50, less than 45, less than 40, less than 35, less than 40, less than 35, less than 30, less than 25, less than 20, less than 15, less than 10, and less than 5 phr (parts per hundred parts resin) plasticizer or a mix of plasticizers. While the interlayers or sheets or layers of the present invention may include at least one plasticizer in the above amounts, it will be understood by one of ordinary skill in the art that plasticizer amount and quantities can be selected as appropriate for the particular application and the desired properties. In various embodiments of interlayers of the present disclosure, an interlayer, sheet or layer may comprise greater than 5 phr, about 5 to about 100 phr, about 10 to about 80 phr, about 30 to about 60 phr, or less than 100 phr, or less than 80 phr total plasticizer. One of ordinary skill will appreciate that, in multilayer interlayer embodiments, the plasticizer selection and content in each individual layer may be selected as appropriate for the desire properties of the particular application and the desired properties of the individual layer as well the overall properties and application of the interlayer.

In addition to polymer resin and optional plasticizer, the polymer resin composition (and accordingly the interlayer, layer or sheet) may include other additives incorporated into the interlayer to enhance its performance in a final product and impart certain additional properties to the interlayer. Such additives include, but are not limited to, dyes, pigments, antioxidants, anti-blocking agents, flame retardants, IR absorbers or blockers (e.g., indium tin oxide, antimony tin oxide, lanthanum hexaboride (LaB₆) and cesium tungsten oxide), UV absorbers, UV stabilizers, processing aids, flow enhancing additives, adhesion agents, lubricants, impact modifiers, nucleating agents, thermal stabilizers, dispersants, surfactants, chelating agents, coupling agents, adhesives, primers, reinforcement additives, and fillers, among other additives known to those of ordinary skill in the art.

Interlayers sheets or layers as described herein may be produced by any suitable process known to one of ordinary skill in the art of producing polymer interlayer sheets that are capable of being used in a multiple layer glazing. For example, it is contemplated that the polymer interlayer sheets may be formed through solution casting, compression molding, injection molding, melt extrusion, melt blowing or any other procedures for the production and manufacturing of a polymer interlayer sheet known to those of ordinary skill in the art. Further, in embodiments where the interlayer, or one or more layers of the interlayer, is a multilayer interlayer, it is contemplated that these multilayer interlayers may be formed through co-extrusion, blown film, dip coating, solution coating, blade, paddle, air-knife, printing, powder coating, spray coating or other processes known to those of ordinary skill in the art. While all methods for the production of interlayers, sheets and layers known to one of ordinary skill in the art are contemplated as possible methods for producing the polymer interlayer sheets described herein, the present invention focuses primarily but not exclusively on interlayers, sheets and layers produced through extrusion and co-extrusion processes.

The interlayer of the present invention includes a thickness or thickness dimension 15 which may also be referred to as the interlayer's gauge. Generally, the thickness or gauge of the interlayer 15 may be in a range from about 15 mils to 1000 mils (about 0.38 mm to about 25.4 mm). Where the interlayer 10 comprises multiple polymer layers or sheets comprising light-reflecting bodies, each polymer layer or sheet having the light-reflecting bodies may have a thickness of about 15 mils to 60 mils (about 0.38 mm to about 1.52 mm) or more, although other thicknesses may be selected as desired. In embodiments where the interlayer is a multilayer interlayer comprising additional layers, each of the additional layers may have a thickness of about 1 mil to 1000 mils (about 0.025 to 25.4 mm), although other thicknesses may be used as desired depending on the application.

As depicted particularly but non-exclusively in FIG. 1A, the interlayer of the present invention further includes a plurality of visible, light-reflecting body precursors 25 within said interlayer thickness 15. In one or more embodiments, the visible, light-reflecting body precursors 25 include a first set 35 of visible, light-reflecting body precursors 25 arranged in a first substantially coplanar arrangement in a first plane XY1 in FIG. 1A within said interlayer thickness and a second set 45 of visible, light-reflecting body precursors 25 arranged in a second substantially coplanar arrangement in a second plane XY2 in FIG. 1A within said interlayer thickness wherein the second plane is substantially parallel to and different from said first plane.

The interlayer of the present invention includes a plurality of visible, light-reflecting body precursors 25 within said interlayer thickness 15. As used herein, the phrase “deformable, visible, light-reflecting body precursors” is intended to generally describe articles that, when subjected to laminating conditions useful in the formation of laminated composite glazings, deform to form visible, light-reflecting bodies as described herein. The phrase “visible, light-reflecting bodies” as used herein is intended to include bodies formed from deformable, visible, light-reflecting body precursors and that reflect electromagnetic energy from at least one surface in at least a portion of the wavelength range that is visible to or detectable by humans.

In one or more embodiments, the first set 35 and second set 45 of deformable, visible, light-reflecting body precursors are each arranged in a substantially coplanar arrangement (referred to respectively as the first substantially coplanar arrangement and second substantially coplanar arrangement) within the interlayer thickness. The term “within” as used to describe the location of the light-reflecting bodies is broadly intended to include locations in the interior 20 of the interlayer thickness as well as locations generally on surfaces 21 and 22 and/or the interior 20 of the interlayer thickness 15.

In one or more embodiments, at least one of the first set 35 of light-reflecting body precursors 25 and the second set 45 of light-reflecting body precursors 25 are arranged in a first substantially coplanar arrangement in the interior of the interlayer thickness 15. In one or more embodiments at least one of or both of the first set 35 of deformable, visible, light-reflecting body precursors 25 and the second set 45 of deformable, visible, light-reflecting body precursors 25 are arranged in a first substantially coplanar arrangement wholly in the interior 20 of the interlayer thickness 15. In one or more embodiments, the surfaces 21 and 22 of the interlayer thickness 15 are devoid of visible, light-reflecting body precursors 25.

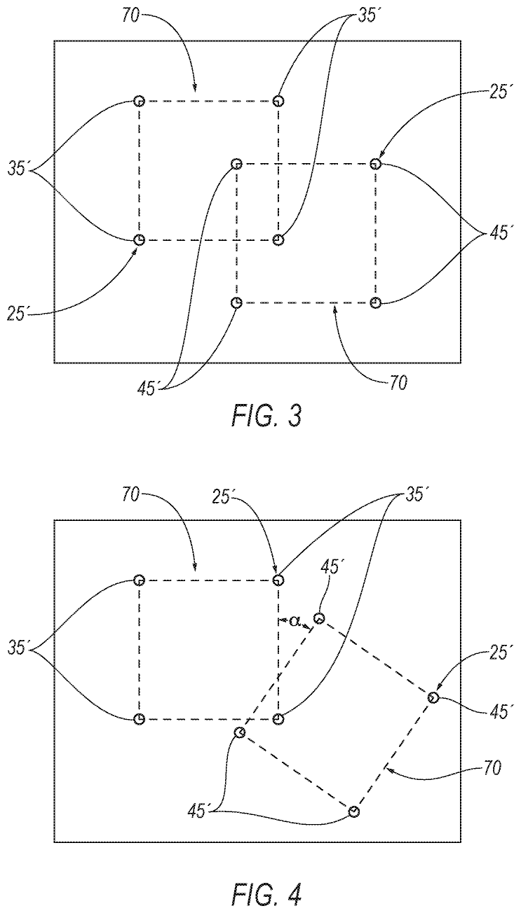

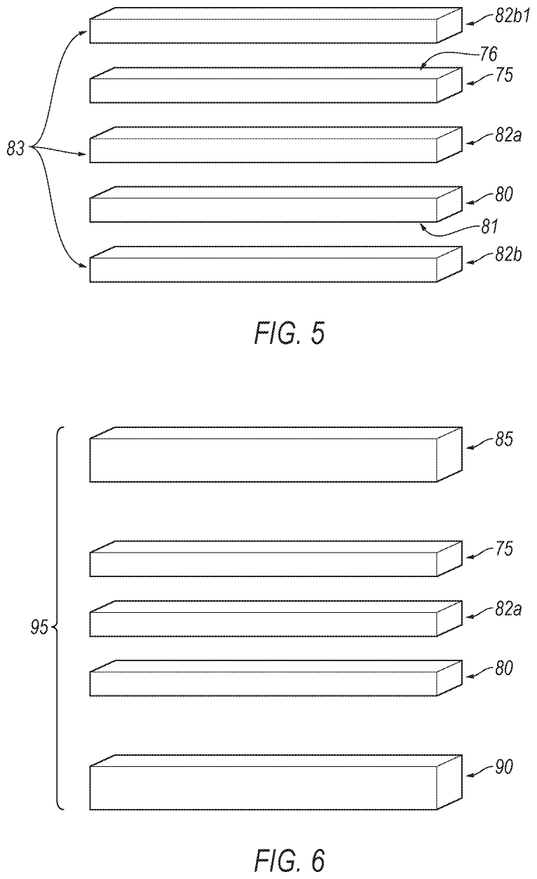

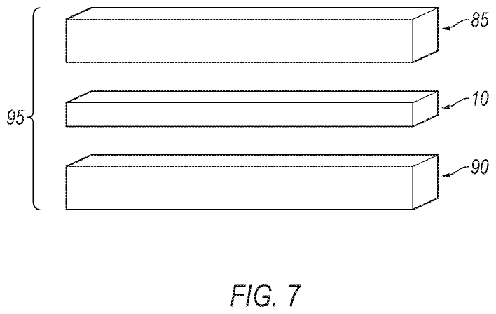

In one or more embodiments, including embodiments describing visible, light-reflecting bodies and visible, light-reflecting body precursors, at least one of said first substantially coplanar arrangement and said second substantially coplanar arrangement comprises a grid pattern. As used herein, the phrase “grid pattern” is intended to describe substantially coplanar arrangements of visible, light-reflecting bodies and/or visible, light-reflecting body precursors wherein imaginary lines (shown as element 70 dotted lines in FIGS. 3 and 4 in depicting visible, light-reflecting bodies) connecting the visible, light-reflecting body precursors or the visible, light-reflecting bodies prior to laminated composite glazing formation of the arrangement form a regular pattern of geometric elements. Non-limiting examples of grid patterns may include rectangles (including more specifically squares as depicted in as FIGS. 3 and 4), triangles, zigzagged lines, parallel lines, intersecting lines or the like. In one or more embodiments, at least one of said first substantially coplanar arrangement and said second substantially coplanar arrangement comprises a rectangular grid pattern. In one or more embodiments, both said first substantially coplanar arrangement and said second substantially coplanar arrangement comprise a grid pattern or preferably a rectangular grid pattern. In one or more embodiments wherein both the first substantially coplanar arrangement and the second substantially coplanar arrangement comprise a grid pattern, wherein the first substantially coplanar arrangement comprises a first grid pattern and the second substantially coplanar arrangement comprises a second grid pattern.

In embodiments wherein both said first substantially coplanar arrangement and said second substantially coplanar arrangement comprise a grid pattern or preferably a rectangular grid pattern, the first grid pattern and the second grid pattern may be staggered. As used herein, the term “staggered” is intended to describe the spatial relationship between a first grid pattern and a second grid pattern wherein (except for minimal random occurrences) no visible, light-reflecting body precursors included in the first grid pattern form an imaginary line with a visible, light-reflecting body precursor included in the second grid pattern that is normal to the first and second planes XY1 and XY2. For reference, magnified excerpts of FIGS. 1A and 1B show a line AB generally normal to first and second planes XY1 and XY2.

Two non-limiting examples of “staggered” spatial relationships contemplated by the present invention include “linearly offset” and “angularly offset”. As used herein, the phrase “linearly offset” is intended to describe spatial relationships between the first and second grid patterns wherein geometric elements of the second grid pattern are offset from the geometric elements of the first grid pattern in an X direction and a Y direction. A non-limiting example of a linear offset arrangement using first and second grid patterns with square geometric elements is depicted in FIG. 3. As used herein, the phrase “angularly offset” is intended to describe spatial relationships between first and second grid patterns wherein the geometric elements of the second grid pattern are offset with a rotational offset angle from the geometric elements of the first grid pattern. A non-limiting example of an angularly offset arrangement using first and second grid patterns with square geometric elements is depicted in FIG. 4, with the rotational offset angle shown as alpha (a). In one or more embodiments, the rotational offset angle α is between 0.1 and 90 degrees or between 90.1 and 179.9 degrees.

In another and related aspect, the present invention relates to a composite 50 comprising an interlayer 10′ and at least one rigid substrate 55 or, in some embodiments and as depicted in FIG. 2, a laminated glazing or laminated composite glazing 100 comprising first and second rigid substrates 55 and 65 with an interlayer 10′ therebetween. The substrates 55 and 65 may be transparent, and in many applications, will be transparent. In this aspect (with reference to FIGS. 1B and 2), the present invention is directed to a composite 50 comprising an interlayer 10′ and a rigid substrate 55 or a laminated composite glazing 100 comprising first and second transparent substrates 55 and 65 with an interlayer 10′ therebetween, said interlayer comprising a polymer resin composition and an interlayer thickness 15′; wherein said interlayer 10′ comprises a plurality of cupped, visible, light-reflecting bodies 25′.

In one or more embodiments, the cupped visible, light-reflecting bodies reflect electromagnetic energy in at least a portion of the wavelength range from 250 nm to 2500 nm. In one or more embodiments, the phrase “visible, light-reflecting bodies” is intended to generally describe articles that reflect electromagnetic energy in at least portion of the wavelength range that is visible to or detectable by most common bird species. In one or more embodiments, the visible, light-reflecting bodies reflect electromagnetic energy in at least a portion of the wavelength range from 250 nm to 700 nm.

In one or more embodiments, the cupped, visible, light-reflecting bodies 25′ may also absorb electromagnetic energy, particularly electromagnetic energy in at least portion of the wavelength range that is visible to or detectable by humans and/or may also absorb electromagnetic energy in at least portion of the wavelength range that is visible to or detectable by common bird species. In one or more embodiments, the visible, light-reflecting bodies 25′ may also absorb electromagnetic energy, particularly electromagnetic energy in at least portion of the wavelength range of 250 nm to 2500 nm and/or may also absorb electromagnetic energy in at least portion of the wavelength range of 250 nm to 400 nm (bird species). In one or more embodiments, the visible, light-reflecting bodies 25′ may include a visible, light-reflecting surface and an opposite visible, light absorbing surface.

The cupped visible, light-reflecting bodies may be of any suitable design, shape, size or configuration that is capable of reflecting (and, in some embodiments, absorbing) electromagnetic energy in the ranges described above. In one or more embodiments, the cupped visible, light-reflecting bodies may be any body or article capable of formation by deformation of a deformable, visible light-reflecting body precursor as described herein when subjected to laminating conditions in the formation of a laminated composite glazing. One example of suitable cupped visible, light-reflecting bodies may be formed from materials described in U.S. Published Patent Application Number 2020/0262185A1, the contents and disclosure of which are hereby incorporated herein by reference to the extent not inconsistent with the present disclosure. The cupped, visible, light-reflecting bodies may be capable of reflecting and in some embodiments absorbing electromagnetic energy on either surface or side of the bodies. Additionally, in some embodiments, the visible, light-reflecting bodies may include a surface with a color generally referred to as silver, but any suitable color(s) may be used as desired. For example, one side or surface of the visible, light-reflecting bodies may be a silver or “shiny” color, while the other or opposite side may be a darker color such as black or have a matte finish.

In one or more embodiments, the visible, light-reflecting bodies are “cupped” or include a first surface which is generally convex and an opposite second surface which is generally concave. In one or more embodiments, the cupped visible, light-reflecting bodies have a shiny or light-reflecting convex surface. In one or more embodiments, the cupped visible, light-reflecting bodies have a shiny or light-reflecting concave surface. In one or more embodiments, the cupped visible, light-reflecting bodies have a dark or matte convex surface. In one or more embodiments, the cupped visible, light-reflecting bodies have a dark or matte concave surface. The cupped, visible light-reflecting bodies may be oriented in the laminated composite glazing in a number of orientations, including a “positive” orientation with a concave surface facing generally upward to face for example the outward surface of a glazing exposed to sunlight or the outdoors or a “negative” orientation with a convex surface facing generally upward as shown in FIG. 9 to face for example the outward surface of a glazing exposed to sunlight or the outdoors.

In one or more embodiments, and with particular reference to FIGS. 1B, 3 and 4, the plurality of visible, light-reflecting bodies 25 includes a first set of visible, light-reflecting bodies 35′ arranged in a first substantially coplanar arrangement in a first plane XY1 within said interlayer thickness 15′ and a second set 45′ of visible, light-reflecting bodies 25 arranged in a second substantially coplanar arrangement XY2 in a second plane within said interlayer thickness that is substantially parallel to and different from said first plane. It will be appreciated by one of ordinary skill that arrangements of visible, light-reflecting bodies as discussed herein are analogous to the arrangements of visible, light-reflecting body precursors as also described herein and depicted in FIG. 1A.

In one or more embodiments, the first set 35′ and second set 45′ of visible, light-reflecting body bodies 25 are each arranged in a substantially coplanar arrangement (referred to respectively as the first substantially coplanar arrangement and the second substantially coplanar arrangement) within the interlayer thickness. The term “within” as used to describe the location of the light-reflecting bodies is broadly intended to include locations in the interior 20 of the interlayer thickness 15 as well as locations generally on surfaces 21 and 22 and/or the interior 20 of the interlayer thickness 15.

In one or more embodiments, at least one of the first set 35′ of light-reflecting bodies 25′ and the second set 45′ of light-reflecting bodies 25′ are arranged in a first substantially coplanar arrangement in the interior of the interlayer thickness 15′. In one or more embodiments at least one of or both of the first set 35 of light-reflecting bodies 25′ and the second set 45′ of light-reflecting bodies 25′ are arranged in a first substantially coplanar arrangement wholly in the interior 20′ of the interlayer thickness 15′. In one or more embodiments, the surfaces 21′ and 22′ of the interlayer thickness 15′ are devoid of visible, light-reflecting bodies 25′.

In one or more embodiments, at least one of said first substantially coplanar arrangement and said second substantially coplanar arrangement comprises a grid pattern. As used herein, the phrase “grid pattern” is intended to describe substantially coplanar arrangements wherein imaginary lines (shown as dotted lines in FIGS. 3 and 4) connecting the visible, light-reflecting bodies or visible, light-reflecting body precursors of the arrangement form a regular pattern of geometric elements. Non-limiting examples of grid patterns may include rectangles (including more specifically squares as depicted in as FIGS. 3 and 4), triangles, zigzagged lines, parallel lines, intersecting lines or the like. In one or more embodiments, at least one of said first substantially coplanar arrangement and said second substantially coplanar arrangement comprises a rectangular grid pattern. In one or more embodiments, both said first substantially coplanar arrangement and said second substantially coplanar arrangement comprise a grid pattern or preferably a rectangular grid pattern. In one or more embodiments wherein both the first substantially coplanar arrangement and the second substantially coplanar arrangement comprise a grid pattern, the first substantially coplanar arrangement comprises a first grid pattern and the second substantially coplanar arrangement comprises a second grid pattern.

In embodiments wherein both said first substantially coplanar arrangement and said second substantially coplanar arrangement comprise a grid pattern or preferably a rectangular grid pattern, the first grid pattern and the second grid pattern may be staggered. As used herein, the term “staggered” is intended to describe the spatial relationship between a first grid pattern and a second grid pattern wherein (except for minimal random occurrences) no visible, light-reflecting bodies included in the first grid pattern form an imaginary line with a visible, light-reflecting body included in the second grid pattern that is normal to the first and second planes XY1 and XY2. For reference, a magnified excerpt of FIG. 1A shows a line AB generally normal to first and second planes XY1 and XY2.

Two non-limiting examples of “staggered” spatial relationships contemplated by the present invention include “linearly offset” and “angularly offset”. As used herein, the phrase “linearly offset” is intended to describe spatial relationships between the first and second grid patterns wherein geometric elements of the second grid pattern are offset from the geometric elements of the first grid pattern in an X direction and a Y direction. A non-limiting example of a linear offset arrangement using first and second grid patterns with square geometric elements is depicted in FIG. 3. As used herein, the phrase “angularly offset” is intended to describe spatial relationships between first and second grid patterns wherein the geometric elements of the second grid pattern are offset with a rotational offset angle from the geometric elements of the first grid pattern. A non-limiting example of an angularly offset arrangement using first and second grid patterns with square geometric elements is depicted in FIG. 4, with the rotational offset angle shown as alpha (a). In one or more embodiments, the rotational offset angle α is between 0.1 and 90 degrees or between 90.1 and 179.9 degrees.

In yet another aspect, the present invention relates to a method for forming a laminated composite glazing that comprises first and second transparent substrates with an interlayer therebetween. The method of the present invention comprises the steps of (a) providing first and second interlayer component sheets 75 and 80, each interlayer component sheet comprising a polymer resin composition and a plurality of deformable, visible, light-reflecting body precursors 25; (b) assembling said first and second interlayer component sheets 75 and 80 to form a multilayer interlayer precursor 83; (c) assembling a laminated composite glazing precursor 95 comprising first and second transparent rigid substrates 55 and 60 with said multilayer interlayer precursor 83 therebetween; and (d) subjecting said laminated composite glazing precursor 95 to laminating conditions to (i) deform said deformable visible, light-reflecting body precursors to form visible, light-reflecting bodies and (ii) form a laminated composite glazing 100 that includes first and second rigid transparent substrates 55 and 65 with an interlayer 10 therebetween.

First and second interlayer component sheets 75 and 80 each include a polymer resin composition and a plurality of deformable visible, light-reflecting body precursors 25. As depicted in FIG. 10, each interlayer component sheet 75 and 80 includes a first surface and a second surface (shown as 76 and 77 with respect to component sheet 75 by way of example). In one or more embodiments, interlayer sheets 75 and 80 each include a plurality of deformable visible, light-reflecting body precursors 25 on at least one surface thereof. In one or more embodiments, the plurality of deformable, visible, light-reflecting body precursors 25 are arranged in a grid pattern. As used herein, the phrase “grid pattern” is intended to describe substantially coplanar arrangements wherein imaginary lines (shown as element 70 dotted lines in FIGS. 3 and 4 in depicting analogous visible, light-reflecting bodies) connecting the visible, light-reflecting body precursors of the arrangement form a regular pattern of geometric elements. Non-limiting examples of grid patterns may include rectangles (including more specifically squares as depicted in as FIGS. 3 and 4), triangles, zigzagged lines, parallel lines, intersecting lines or the like.

In one or more embodiments, the first and second interlayer component sheets 75 and 80 are assembled in an adjacent stacked arrangement in assembling step (b). In one or more embodiments, step (b) of assembling the first and second interlayer component sheets 75 and 80 to form a multilayer interlayer precursor 83 may further include inserting one or more optional component sheets, generally depicted in FIG. 5 as element(s) 82. In one or more embodiments, optional interlayer component sheets do not include deformable, visible, light-reflecting body precursors. In one or more embodiments, the optional interlayer component sheet is a spacer sheet (shown in FIG. 5 as element 82a) located between the first and second interlayer component sheets 75 and 80. Accordingly, in one or more embodiments, step (b) of assembling the first and second interlayer component sheets 75 and 80 to form a multilayer interlayer precursor 83 may further include inserting one or more optional spacer sheet(s) 82a between the first and second interlayer component sheets 75 and 80. In such embodiments, interlayer component sheet 75 and interlayer component sheet 80 each may include deformable, visible, light-reflecting body precursors on a surface facing the optional spacer sheet.

In one or more embodiments, the optional interlayer component sheet may be an optional cap sheet (shown in FIG. 5 as elements 82b and 82b1) located adjacent an opposing or outwardly facing surface 76 or 81 of an interlayer component sheet 75 or 80 or between one or more interlayer component sheets 75 or 80 and one or more transparent substrates. Accordingly, in one or more embodiments, step (b) of assembling the first and second interlayer component sheets 75 and 80 to form a multilayer interlayer precursor 83 may further include inserting one or more optional cap sheets adjacent an opposing or outwardly facing surface 76 or 81 respectively of at least one of the first and second interlayer component sheets 75 and 80 or between an interlayer component sheet and a transparent substrate. In such embodiments, at least one of interlayer component sheet 75 and interlayer component sheet 80 may include deformable, visible, light-reflecting body precursors on a surface facing the optional cap sheet.

Optional interlayer component sheet 82 may be any thickness as desired and previously described and may be thinner or thicker than the first and second interlayer component sheets 75 and 80.

In a further embodiment, step (b) of assembling the first and second interlayer component sheets 75 and 80 to form a multilayer interlayer precursor 83 may include inserting both an optional spacer sheet(s) 82a and an optional cap sheet 82b and/or 82b1. In another embodiment, the first and second interlayer component sheets 75 and 80 may be positioned such that the deformable, visible, light-reflecting body precursors 25 are on the same side or surface of the interlayer component sheets or facing surfaces of the first and second interlayer component sheets 75 and 80 or at the same interface or at one or more surfaces of the first and second interlayer component sheets 75 and 80 facing one or more transparent substrates. In yet another embodiment, there may be an optional layer located between at least one of the first and second interlayer sheets 75 and 80, adjacent the rigid substrate. This layer may be another polymer layer of the same or different composition, and it may have the same or different properties (such as a decorative color, solar absorbing properties, or other function or property) as one or both of the interlayer sheets 75 and 80. Regardless of the embodiment utilized, it may be appreciated by one or ordinary skill and should be understood that placement, position, orientation and arrangement of the first and second interlayer sheets 75 and 80 in the assembling step (b) may be selected such that the interlayer of the laminated composite glazing produced according to the method includes a first set 35′ of cupped, visible, light-reflecting bodies 25′ arranged in a first substantially coplanar arrangement in a first plane XY1 and a second set 45′ of cupped, visible, light-reflecting bodies 25′ arranged in a second substantially coplanar arrangement XY2 in a second plane within said interlayer thickness that is substantially parallel to and different from said first plane.

In the method of this aspect, first and second interlayer component sheets 75 and 80 each include a polymer resin composition and a plurality of deformable, visible, light-reflecting body precursors 25. In one or more embodiments, first and second interlayer component sheets 75 and 80 each comprise a plurality of deformable, visible, light-reflecting body precursors on at least one surface thereof. As described in the method of this aspect, the first and second interlayer component sheets 75 and 80 form a multilayer interlayer precursor 83 in assembling step (b) and then form interlayer 10′ in assembling step (c). Further, the deformable, visible, light-reflecting body precursors 25 of the first interlayer component sheet 75 form and correspond to the first set 35′ of cupped, visible, light-reflecting bodies 25′ of the interlayer 10′ while the deformable, visible, light-reflecting body precursors of the second interlayer component sheet 80 form and correspond to the second set 45′ of cupped, visible, light-reflecting bodies 25′ of the interlayer 10′ after formation of the laminated composite glazing. Accordingly, in one or more embodiments, assembling step (b) includes arranging first and second interlayer component sheets 75 and 80 such that the interlayer of the laminated composite glazing produced according to the method includes a first set 35′ of cupped, visible, light-reflecting bodies 25′ arranged in a first substantially coplanar arrangement in a first plane XY1 and a second set 45′ of cupped, visible, light-reflecting bodies 25′ arranged in a second substantially coplanar arrangement XY2 in a second plane within said interlayer thickness that is substantially parallel to and different from said first plane.

In one or more embodiments, at least one of or both of the first and second interlayer component sheets 75 and 80 comprise a plurality of deformable, visible, light-reflecting body precursors arranged in a substantially coplanar arrangement. In one or more embodiments, at least one of or both of the first and second interlayer component sheets 75 and 80 comprise a plurality of deformable, visible, light-reflecting body precursors arranged on a surface thereof. In one or more embodiments, at least one of or both of the first and second interlayer component sheets 75 and 80 comprise a plurality of deformable, visible, light-reflecting body precursors 25 arranged in a grid pattern.

One of ordinary skill will appreciate that, in practicing the method of this aspect of the present invention, the interlayer component sheets 75 and 80 may or may not (depending on factors such as for example laminating conditions and variables, equipment and settings) completely combine or integrate in forming the interlayer 10 resulting from assembling step (c). Accordingly, in one or more embodiments, the interlayer may be characterized as a monolithic interlayer while, in one or more embodiments, the interlayer 10 may be characterized as a multilayer interlayer. Further, in one or more embodiments, the interlayer may be a hybrid interlayer 10 with both monolithic and multilayer portions. In embodiments, the interlayer 10 may include additional layers that may or may not be polymeric layers, or may be layers of different polymer compositions and/or functionality, as previously described.

In the above method, interlayer component sheets, including optional component sheets, are assembled. In another aspect, therefore, the present invention relates to a component interlayer sheet that is useful in forming for example a composite comprising an interlayer 10 and a rigid substrate 55 or more particularly a laminated glazing or laminated composite glazing comprising first and second rigid substrates 55 and 65 with an interlayer 10′ therebetween. In this aspect, the present invention is directed to an interlayer component sheet, wherein said interlayer component sheet includes a polymer resin composition and a plurality of deformable visible, light-reflecting body precursors. An example of an embodiment of an interlayer component sheet of the present invention is depicted in FIG. 10. An interlayer component sheet includes a first surface 76 and a second surface 77. In one or more embodiments, interlayer sheets 75 includes a plurality of deformable visible, light-reflecting body precursors 25 on at least one surface thereof. In one or more embodiments, the plurality of deformable visible, light-reflecting body precursors 25 are arranged in a grid pattern as described elsewhere herein. Substrates may be formed from or include polymer resin compositions known in the art of laminated glazing interlayer manufacture and/or as described herein with respect to the interlayer of the present invention. The resin compositions may generally include one or more polymeric resins, optionally combined with one or more plasticizers, which have been formed into a sheet by any suitable method. Useful polymeric resins generally include without limitation polyvinyl acetals, thermoplastic polyurethanes, ethylene vinyl acetate, ionomeric resins and the like. In various embodiments, the interlayer or sheet or layer includes a polymer or polymer resin or resin composition that comprises a poly(vinyl acetal) resin and in particular a polyvinyl butyral (PVB) resin. Substrate thickness for the interlayer component sheet may vary depending on a number of factors, including without limitation polymer composition, desired interlayer thickness, lamination conditions, presence or absence of optional component sheets and total number of component sheets.

In a non-limiting and exemplary embodiment described herein, laminated composite glazings may be formed by a method that includes assembling multiple (e.g., first and second) interlayer component sheets. One or ordinary skill will appreciate, however, that useful composites may be formed using single interlayer component sheets of the present invention. In one non-limiting example, a useful composite could be formed by assembling and laminating a rigid substrate, an interlayer component sheet including a substrate and a plurality of deformable visible, light-reflecting body precursors on at least one surface thereof and an optional spacer sheet between the substrate and the precursor. In another non-limiting example, a useful laminated composite glazing could be formed by assembling and laminating first and second rigid transparent substrates with an interlayer therebetween wherein the interlayer includes an interlayer component sheet including a substrate and a plurality of deformable visible, light-reflecting body precursors on at least one surface thereof between first and second optional spacer sheets.

In still another aspect, the method of the present invention is a method for forming a laminated composite glazing comprising first and second transparent substrates with an interlayer therebetween, said method comprising the steps of (a) providing an interlayer 10 with a thickness 15 and comprising (i) a polymer resin composition and (ii) a plurality of deformable visible, light-reflecting body precursors 25; wherein said plurality of deformable visible, light-reflecting body precursors includes a first set of deformable visible, light-reflecting body precursors 35 arranged in a first substantially coplanar arrangement in a first plane XY1 within said interlayer thickness 15 and a second set 45 of deformable visible, light-reflecting body precursors arranged in a second substantially coplanar arrangement in a second plane XY2 within said interlayer thickness 15 that is substantially parallel to and different from said first plane; (b) assembling a laminated composite glazing precursor 95 comprising first and second transparent substrates 85 and 90 with said interlayer 10 therebetween; and (d) subjecting said laminated composite glazing precursor 95 to laminating conditions to (i) deform said deformable visible, light-reflecting body precursors to form cupped, visible, light-reflecting bodies and (ii) form a laminated composite glazing 100.

Laminated glazings and laminated composite glazings such as those described herein and those including interlayers of the present invention are prepared by known procedures, e.g., as disclosed in U.S. Pat. Nos. 5,024,895; 5,091,258; 5,145,744; 5,189,551; 5,264,058 and 5,529,654 (all of which are incorporated herein by reference). In general, an interlayer is placed between two sheets of rigid substrates (such as glass) and deaired through nip rollers, calendar rollers or with vacuum to remove excess air between the interlayers and the interlayers and glass surface. The deaired laminated composite glazing is the heated, optionally under pressure, for a sufficient time at a sufficient temperature to firmly bond the layers of the laminate. This process is done in both an autoclave or non-autoclave methods as known in the art, and for example, as disclosed in U.S. Pat. No. 5,536,347, incorporated herein by reference.

Laminating conditions such as temperature, pressure, lamination time and the like should be identified and selected so as to achieve the purposes and intent of the present invention, including (i) deforming the deformable visible, light-reflecting body precursors to form cupped, visible, light-reflecting bodies therefrom and (ii) forming a laminated composite glazing. One of ordinary skill will appreciate that identification and selection of laminating conditions that in combination will meet this criteria will depend on a number of factors, including for example the use of interlayer component sheets and/or optional component sheets, interlayer and component sheet thicknesses, polymer compositions, materials used in forming component sheet substrates, rigid substrate type and thickness, laminating equipment type and interaction of laminating condition variables. Lamination may be performed using known techniques such as vacuum processes or nip roll processes and will typically involve use of an autoclave in an autoclave processing step, with the step of deforming the deformable visible, light-reflecting body precursors of the present method occurring during the autoclave processing step. The autoclave processing step may include periods of temperature/pressure increasing or ramping, temperature/pressure plateau, and temperature/pressure decreasing. The whole autoclave processing step could take between one to four hours depending on the size of the laminates and the size of the autoclave, with typical plateau temperatures of from 125° C. to 165° C. and plateau pressures of from 70 to 95 psi.

One of ordinary skill will understand and appreciate that elements or features used to describe one aspect or embodiment of the present invention may be applicable and useful in describing other aspects or embodiments. By way of non-limiting example, the description of a visible, light-reflecting body set forth in the context of the interlayer of the present invention is also applicable and useful in describing the visible, light-reflecting body in the context of composites and laminated composite glazings and methods of the present invention. Similarly, descriptions and Figure depictions relating to the patterns, positions and arrangements of deformable, visible, light-reflecting body precursors set forth herein are also applicable and useful in describing the patterns, positions and arrangements of visible, light-reflecting bodies. Accordingly, descriptions and disclosure relating to elements or features of an aspect or embodiment of the present invention are hereby expressly relied on to describe and support those elements or features in other aspects or embodiments.

The following examples, while provided to illustrate with specificity and detail the many aspects and advantages of the present invention, are not to be interpreted as in any way limiting its scope. Variations, modifications and adaptations which do depart of the spirit of the present invention will be readily appreciated by one of ordinary skill in the art.

### Materials:

Deformable, visible, light-reflecting body precursors (“precursors”): Precursors were procured from Seen GmbH in the form of an adhesive-coated raw precursor film from which round precursors were “punched” out. Precursors were round, substantially flat discs, 9 mm in diameter, with a polyethylene (PET) substrate. For items listed and described in Tables 1 to 3 below, the precursor had a first (top) surface coated with shiny aluminum and a second (bottom) surface coated with dark ink.

### Interlayer Component Sheet Substrates:

Saflex® RB41 PVB (RB41): 0.76 mm sheet of polyvinyl butyral (PVB) with relatively low stiffness and low flow (RB41 composition Shear Modulus at 20° C. of 15 MPa) (commercially available from Eastman Chemical Company).

Saflex® RB11 PVB (RB11): 0.38 mm sheet of PVB of same composition as PVB for RB41 (commercially available from Eastman Chemical Company).

Saflex® DG41 PVB (DG41): 0.76 mm sheet of PVB with relatively high stiffness (DG41 composition Shear Modulus at 20° C. of 320 MPa) (commercially available from Eastman Chemical Company).

Saflex® DM PVB (DM): 0.76 mm sheet of PVB with relatively medium high stiffness (DM composition Shear Modulus at 20° C. of 100 MPa) (commercially available from Eastman Chemical Company).

Saflex® AC41 PVB (AC41): 0.76 mm sheet of PVB with relatively low stiffness and low flow (AC41 composition Shear Modulus at 20° C. of 5 MPa) (commercially available from Eastman Chemical Company).

Saflex® QS41 PVB (QS41): 0.76 mm sheet of PVB with relatively low stiffness and low flow (QS41 composition Shear Modulus at 20° C. of 3 MPa) (commercially available from Eastman Chemical Company).

EVA: 0.38 mm sheet of ethylene vinyl acetate, relatively low stiffness and high flow (EVA composition Shear Modulus at 20° C. less than 1 MPa) (commercially available as Evguard® colorless transparent EVA interlayer from Folienwerk Wolfen GmbH).

TPU: 0.38 mm sheet of aliphatic thermoplastic polyurethane, relatively low stiffness and high flow (TPU composition Shear Modulus at 20° C. of 5 MPa) (commercially available, such as from Huntsman and Argotec).

Ionomer: 0.94 mm sheet of ionomer sheet having relatively high stiffness and high flow (Ionomer composition Shear Modulus at 20° C. of 280 MPa) (such as SentryGlas, available commercially, for example, from Kuraray).

### Sample Preparation:

For each sample, precursors were arranged colored (dark) side down in a generally square grid pattern with even distribution (10 cm apart from each other) on the surface of an interlayer substrate (cut slightly larger than the glass substrate size) to form an interlayer component sheet. The interlayer component sheet was placed on a preheated (to about 50° C.) clear glass substrate (either 4 inch by 4 inch or 6 inch by 6 inch and 3.0 mm thick) with precursors facing away from the glass. A second sheet of interlayer material of a size and shape substantially matching that of the substrate with the precursors was then placed on the surface of the substrate that included the precursors. Next, (except for a control item), a second preheated (to about 50° C.) clear glass substrate (either 4 inch by 4 inch or 6 inch by 6 inch and 3.0 mm thick) was placed on the second sheet of interlayer material to form an assembly. Various interlayer subassemblies using various types of interlayer materials were prepared as listed in the Tables below. Each assembly was then processed through a nip roll and excess edge sheet material trimmed. The edge-trimmed assembly was then autoclaved at a peak temperature of 143° C. and peak pressure of 85 psi for a plateau time of 15 minutes and a total time cycle of about one hour.

### Analytical Procedure:

Deformation of the precursors during the lamination procedure was evaluated and quantified. Specifically, for each laminated composite glazing, precursor deformation between two layers of substrate material within a laminate was measured using a Lumetrics Optigauge system based on a quantifiable difference in refractive index of the laminate glazing components. With this system, an infrared laser was scanned through the thickness of the laminated glazing, with a reflected laser signal directed towards a control module inside a computer. This reflected signal was then analyzed by software along with calculated layer thicknesses. For this example, the laser signal was blocked by a cupped, visible light-reflecting body when the laser was scanned across the laminate, with the blockage data used to locate and back-calculate the amount of precursor deformation. The amount of deformation for all bodies in a given sample was compared and the maximum/largest deformation for each sample tabulated in the Tables 1 through 3 below.

TABLE 1

| | Largest |
|---|---|
| | deformation |
| Laminate Sample Construction | (mm) |
| RB41 - Precursor - Glass (Control Sample) | 0.01 |
| DG41 - Precursor - DG41 | 0.08 |
| DM - Precursor - DM | 0.15 |
| RB41 - Precursor - RB41 | 0.20 |
| AC41 - Precursor - AC41 | 0.30 |

TABLE 2

| Material | Largest deformation (mm) |
|---|---|
| RB11 - Precursor - RB11 | 0.13 |
| RB41 - Precursor - RB41 | 0.20 |

TABLE 3

| Material | Largest deformation (mm) |
|---|---|
| RB11 - Precursor - RB11 | 0.13 |
| EVA - Precursor - EVA | 0.13 |
| TPU - Precursor - TPU | 0.15 |
| DG41 - Precursor - DG41 | 0.08 |
| Ionomer - Precursor - Ionomer | 0.18 |

Additional samples were also prepared in the same manner for evaluation, with certain deformable, visible, light reflecting precursors including those described above and others having a matte aluminum finish on one surface instead of a shiny aluminum finish. Samples were prepared, processed and analyzed according to the above procedures. In the additional samples, it was noted that precursors deformed such that the matte aluminum surface of the resulting cupped body corresponded to a concave surface while the shiny aluminum surface corresponded to a convex surface. Results are shown in Table 4 below, with the largest deformation generally occurring at the geometric center of the precursor.

TABLE 4

| Material | Largest deformation (mm) |
|---|---|
| EVA - Precursor - EVA | Shiny: 0.13 |
| | Matte: 0.11 |
| RB41 - Precursor - RB41 | Shiny: 0.15 |
| | Matte: 0.13 |
| RB41 - Precursor - QS41 (RB41 | Shiny: 0.13 |
| on top) | Matte: 0.13 |
| QS41 - Precursor - RB41 (QS41 | Shiny: 0.14 |
| on top) | Matte: 0.15 |
| RB41 - Precursor - DG41 (RB41 | Shiny: 0.10 |
| on top) | Matte: 0.12 |
| DG41 - Precursor - RB41 (DG41 | Shiny: 0.13 |
| on top) | Matte: 0.08 |

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An interlayer for a laminated composite, said interlayer comprising an interlayer thickness, a polymer resin composition and a plurality of deformable, visible, light-reflecting body precursors.

2. The interlayer of claim 1 wherein said deformable visible, light-reflecting body precursors are substantially flat.

3. The interlayer of claim 1 wherein said deformable visible, light-reflecting body precursors comprise a first surface and an opposite second surface at least one of which is generally planar.

4. The interlayer of claim 1 wherein said deformable visible, light-reflecting body precursors deform or are capable of deforming during formation of a laminated composite glazing to form cupped, visible, light-reflecting bodies with a deformation distance of at least 0.05 mm.

5. The interlayer of claim 4 wherein said cupped, visible, light-reflecting bodies have a concave shape.

6-8. (canceled)

9. A laminated composite glazing comprising first and second transparent substrates with an interlayer therebetween, said interlayer comprising a polymer resin composition and an interlayer thickness; wherein said interlayer comprises a plurality of cupped, visible, light-reflecting bodies.

10. The laminated composite glazing of claim 9 wherein said cupped, visible, light-reflecting bodies are formed from deformable visible, light-reflecting body precursors during formation of said laminated composite glazing.

11. The laminated composite glazing of claim 9 wherein said cupped, visible, light-reflecting bodies have a concave shape.

12. A method for forming a laminated composite glazing comprising first and second transparent substrates with an interlayer therebetween, said method comprising the steps of (a) providing first and second interlayer component sheets, each interlayer component sheet comprising a substrate and a plurality of deformable, visible, light-reflecting body precursors; (b) assembling said first and second interlayer component sheets to form a multilayer interlayer precursor; (c) assembling a laminated composite glazing precursor comprising first and second transparent substrates with said multilayer interlayer precursor therebetween; and (d) subjecting said laminated composite glazing precursor to laminating conditions to (i) deform said deformable, visible, light-reflecting body precursors to form cupped, visible, light-reflecting bodies therefrom and (ii) form said laminated composite glazing.

13. The method of claim 12 wherein said first and second interlayer component sheets each comprise a plurality of deformable visible, light-reflecting body precursors arranged in a grid pattern.

14. The method of claim 12 wherein said deformable visible, light-reflecting body precursors are arranged in a grid pattern on at least one surface of each of said first and second interlayer component sheets.

15. The method of claim 12 wherein said assembling step (b) further comprises inserting one or more optional spacer sheet(s) between said the first and second interlayer component sheets.

16. The method of claim 12 wherein said assembling step (b) further comprises inserting one or more optional cap sheets adjacent an opposing or outwardly facing surface of at least one of the first and second interlayer component sheets.

17. (canceled)
